(19) United States
(12) Patent Application Publication
(10) Pub. No.: US 2026/0014844 A1
(43) Pub. Date: Jan. 15, 2026

(54) ROOF SIDE RAIL ASSEMBLY FOR A VEHICLE

(71) Applicants: HYUNDAI MOTOR COMPANY, Seoul (KR); KIA CORPORATION, Seoul (KR)

(72) Inventors: Hyung-Sik Choi, Hwaseong-si (KR); Soo-Bok Kim, Hwaseong-si (KR); Sang-Hyun Lee, Hwaseong-si (KR); Joong-Hyun Shin, Hwaseong-si (KR); Jae-Seung Lee, Hwaseong-si (KR); Gook-Hyun Jeon, Hwaseong-si (KR); Jea-Hong Kim, Hwaseong-si (KR); Sun-Hyung Cho, Hwaseong-si (KR); Jin-Ho Hwang, Hwaseong-si (KR); Jung-Jong Chun, Yangsan-si (KR); Yoon-Kyoung Han, Incheon (KR); Ji-Yun Cha, Yangsan-si (KR)

(73) Assignees: HYUNDAI MOTOR COMPANY, Seoul (KR); KIA CORPORATION, Seoul (KR)

(21) Appl. No.: 18/961,086

(22) Filed: Nov. 26, 2024

(30) Foreign Application Priority Data
Jul. 11, 2024 (KR) 10-2024-0091702

(51) Int. Cl. B60J 10/90; B60J 7/16; B60J 10/30

(52) U.S. Cl. CPC B60J 10/90; B60J 7/1642; B60J 10/30

(57) ABSTRACT

A roof side rail assembly for a vehicle may seal a perimeter of a roof panel in a vehicle from which the roof panel may be separated. The roof side rail assembly includes a roof side rail disposed in a longitudinal direction of the vehicle on a side surface of a roof of a vehicle and includes an auxiliary rail formed in the longitudinal direction of the vehicle, fastened to an outer side of the vehicle in a width direction at the roof side rail, and having weather strips mounted thereon to seal a gap between a roof panel mounted on the roof and a door glass.

### CROSS-REFERENCE TO RELATED APPLICATION

This application claims priority to Korean Patent Application No. 10-2024-0091702, filed on Jul. 11, 2024, and which is incorporated herein by reference in its entirety.

### BACKGROUND

### Technical Field

The present disclosure relates to a roof side rail assembly for a vehicle, which may seal a perimeter of a roof panel in a vehicle from which the roof panel may be detachable.

### Description of Related Art

A technology for opening a roof of a vehicle so that passengers may feel a further expanded (i.e., enhanced) sense of openness is being applied to vehicles.

For example, as shown in FIGS. 1 and 2, in some vehicle types, a roof panel 150 of a vehicle 100 may be detachably attached by a passenger so that the vehicle 100 may travel in a state in which the roof is opened, thereby allowing the passenger to feel the expanded sense of openness. When the passenger manually removes the roof panel 150 of the vehicle 100, only a frame, such as a roof side rail 120 and a center rail 112 of the vehicle 100 remains and the roof panel 150 is removed, and thus the passenger may feel the expanded sense of openness.

In addition, in a limited traveling environment, a door 160 may also be removed to maximize the sense of openness.

As described above, in a vehicle in which the roof panel 150 is detachably attached, the roof side rail 120 is manufactured by hot blow molding to reinforce the rigidity of the roof of the vehicle 100 so that a cross section of the roof side rail 120 is formed as a closed cross section.

In the vehicle to which the roof panel 150 is detachably attached, the roof side rail 120 is exposed when the roof panel 150 is removed to have a strong visual appearance, and the roof side rail 120 is formed to have the closed cross section to have sufficient rigidity. Through the hot blow molding process, the roof side rail 120 is formed to have a closed cross section in a tubular shape. As shown in FIG. 2, when the roof side rail 120 is formed to have the closed cross section, it is not easy to install a weather strip for sealing because there is no protruded part protruding to the outside.

Therefore, in some vehicle types, the weather strip is not applied between the roof side rail 120 and the roof panel 150, and only a glass weather strip that seals an upper end of a door glass is applied. As described above, when the weather strip is not applied between the roof side rail 120 and the roof panel 150, there is a problem that sealing performance is degraded when the vehicle travels after mounting the roof panel 150. In addition, external noise cannot be effectively blocked.

To solve these problems, a carrier is additionally mounted on the roof side rail 120 and a body weather strip is mounted on the carrier so that a gap between the roof side rail 120 and the roof panel 150 is sealed. However, the additional installation of the carrier becomes a factor in increasing the manufacturing and part cost.

In this case, the body weather strip and the roof panel 150 are simply in contact and sealed.

As described above, in the roof side rail 120 according to the related art, it is not easy to mount the weather strip, and there is a problem that sealing performance is not excellent.

There is a problem that poor sealing occurs due to the assembly dispersion of the roof panel 150 according to the repeated installation and removal of the roof panel 150.

### SUMMARY

The present disclosure has been invented to solve the above-noted problems and is directed to providing a roof side rail assembly for a vehicle, which can improve sealing performance of a roof panel and achieve sealing performance regardless of the assembly dispersion of a roof by sealing the roof panel multiple times upon mounting.

A roof side rail assembly for a vehicle according to an embodiment of the present disclosure for achieving the above objects includes a roof side rail disposed along a longitudinal direction of the vehicle on each of side surfaces of a roof of the vehicle and includes an auxiliary rail formed along the longitudinal direction of the vehicle. The auxiliary rail is fastened to an outer side of the vehicle in a width direction at the roof side rail and has a weather strip sealing a gap between a roof panel mounted on the roof and a door glass mounted on the roof.

The roof side rail assembly further includes an upper roof weather strip installed above the auxiliary rail to seal a gap between the roof panel and the roof side rail and includes a lower roof weather strip having one side fitted into an end portion of the auxiliary rail and installed below the auxiliary rail to seal gaps between the roof panel, the door glass, and the vehicle body.

The auxiliary rail includes a fastening part assembled to an outer surface of the roof side rail and an extension extending outward from the fastening part in the width direction of the vehicle. The upper roof weather strip is fixed to an upper end of the fastening part above the extension. The lower roof weather strip is fixed to an end portion of the extension and a lower end of the fastening part.

The upper roof weather strip includes: a fixing part fastened to the auxiliary rail; and a roof bottom sealing part formed convexly toward a bottom surface of the roof panel to be in contact with a lower end of the roof panel and allowing the upper roof weather strip to have a hollow together with the fixing part.

The auxiliary rail further includes an upper hook part formed at an upper end of the fastening part. One side of the fixing part of the upper roof weather strip is coupled to the upper hook part, and the other side of the fixing part is fixed to the lower roof weather strip.

The extension has an upper portion sealed with the roof panel and a lower portion sealed with the door glass. The roof panel and the door glass are independently sealed to the extension.

A side end of the roof panel is sealed in contact with side surfaces of the upper roof weather strip and the lower roof weather strip.

An upper end of the door glass is sealed in contact with a lower portion of the lower roof weather strip.

The auxiliary rail includes: a center hook part extending vertically from the end portion of the extension and allowing one side of the lower roof weather strip to be fixedly fitted into the center hook part; a catch part extending downward from the center hook part to catch and fix the one side of the lower roof weather strip to prevent separation of the lower roof weather strip; and a lower hook part formed at the lower end of the fastening part to fix the other side of the lower roof weather strip.

The auxiliary rail is formed in an H shape as the fastening part and the center hook part each extends vertically from one of both ends of the extension.

The lower roof weather strip includes a support part supported by a bottom surface of the extension, an upper gripping part fixedly caught on (e.g., engaged with, held on, and/or secured by) the center hook part, and a roof side sealing part sealing a perimeter of the roof panel at an end portion of the lower roof weather strip.

The lower roof weather strip has an opening through which the center hook part and the catch part of the auxiliary rail pass formed between the support part and the upper gripping part.

A fixing groove is formed inside the roof side sealing part. The fixing groove is fixedly caught on (e.g., engaged with, held on, and/or secured by) the catch part.

The roof side rail assembly further includes a glass upper sealing part extending from the roof side sealing part to an inside of the vehicle, forming a hollow structure together with the support part, and sealing the upper end of the door glass.

The roof side rail assembly further includes a first glass side sealing part extending from an inner end portion of the support part and sealing an inner upper portion of the door glass below the glass upper sealing part and includes a lower gripping part protruding from a side surface of the first glass side sealing part and fixedly caught on (e.g., engaged with, held on, and/or secured by) the lower hook part.

The roof side rail includes a roof side outer part (also referred as a roof side outer hereinafter) formed to have a cross section that is convex to the outside of the vehicle, and a roof side inner part (also referred as a roof side inner) formed to have a cross section that is convex to the inside of the vehicle. The roof side inner part has upper and lower portions respectively assembled to upper and lower portions of the roof side outer part. The auxiliary rail is fastened to the roof side outer part.

The roof side rail assembly further includes an outer lower flange part is formed to face a lower portion of the vehicle below the roof side outer part, an inner lower flange part extending from the lower portion of the roof side inner part in the same direction as the outer lower flange part and assembled to the outer lower flange part, and a body weather strip fitted into the outer lower flange part and the inner lower flange part to seal a gap between the upper portion of the door glass and the roof side rail.

The body weather strip seals side surfaces of the door glass below the lower roof weather strip.

The roof side rail assembly further includes an outer upper flange part is formed to face the inside of the vehicle above the roof side outer and an inner upper flange part formed to face the outside of the vehicle above the roof side inner and overlapping the outer upper flange part. The outer upper flange part and the inner upper flange part are assembled so that upper portions of the roof side outer and the roof side inner are assembled.

According to the roof side rail assembly for a vehicle of the present disclosure having the above configuration, the perimeter of the roof panel is sealed multiple times when the roof panel is mounted, thereby firmly sealing the gap between the perimeter of the roof panel and the roof side rail.

In addition, as the auxiliary rail is installed from the front filler to the rear filler in the longitudinal direction of the vehicle at the outside of the roof side rail and the weather strip is installed on the auxiliary rail, the part at which the roof side rail is connected to the center filler, and the like has no step, thereby improving aesthetics.

In addition, since the perimeter of the roof panel is sealed multiple times, even when dispersion occurs upon assembly of the roof panel, the assembly dispersion does not affect sealing performance.

Since the weather strip for sealing the roof panel, the door glass, and the roof side rail is not mounted on the roof panel, even when the roof panel is detachably attached repeatedly, it is possible to prevent damage to the weather strip.

### BRIEF DESCRIPTION OF THE DRAWINGS

FIG. 1 is a perspective view showing a vehicle to which a roof side rail for a vehicle according to the related art is applied.

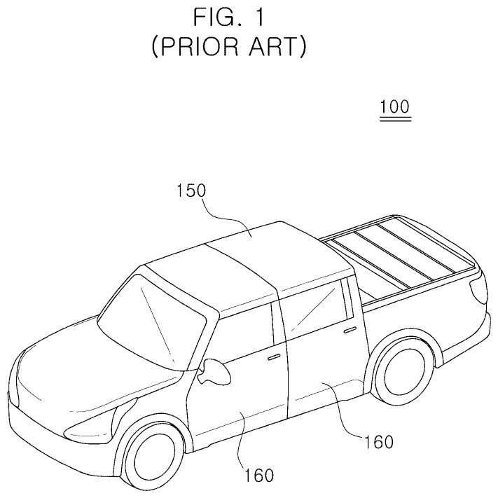

FIG. 2 is a perspective view showing a state in which a roof panel has been detached from the vehicle to which the roof side rail for a vehicle according to the related art is applied.

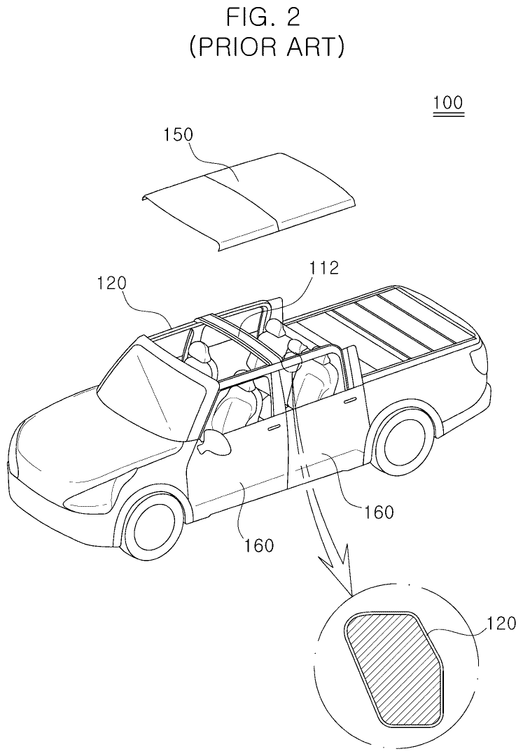

FIG. 3 is a perspective view showing a vehicle to which a roof side rail assembly for a vehicle according to an embodiment of the present disclosure is applied.

FIG. 4 is a cross-sectional view along line I-I in FIG. 3.

FIG. 5 is a cross-sectional view showing a state in which an upper roof weather strip, a lower roof weather strip, and a body weather strip have been installed on a roof side rail and an auxiliary rail in the roof side rail assembly for a vehicle according to an embodiment of the present disclosure.

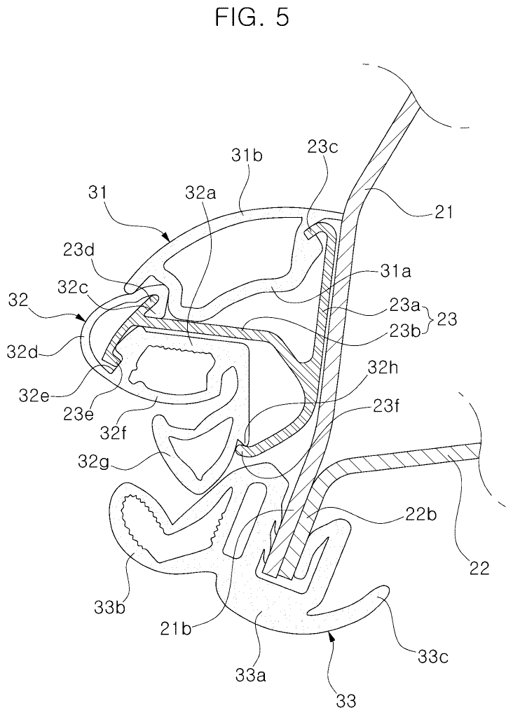

FIG. 6 is an exploded view showing the coupling relationship between an auxiliary rail, an upper roof weather strip, and an lower roof weather strip in the roof side rail assembly for a vehicle according to an embodiment of the present disclosure.

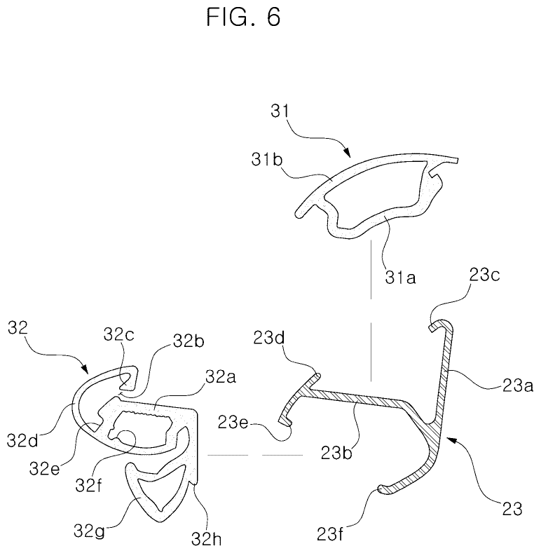

FIG. 7 is a perspective view showing a state in which a roof panel has been detached from a vehicle to which a roof side rail assembly for a vehicle according to an embodiment of the present disclosure is applied.

FIG. 8 is a cross-sectional view along line II-II in FIG. 7.

FIG. 9 is a cross-sectional view showing a state in which dispersion occurs when a roof panel is coupled in a vehicle to which a roof side rail assembly for a vehicle according to an embodiment the present disclosure is applied.

### DETAILED DESCRIPTION

Hereinafter, a roof side rail assembly for a vehicle according to embodiments the present disclosure is described in detail with reference to the accompanying drawings. When a component, device, element, or the like of the present disclosure is described as having a purpose or performing an operation, function, or the like, the component, device, element, or the like should be considered herein as being “configured to” meet that purpose or perform that operation or function.

The roof side rail assembly for a vehicle according to an embodiment of the present disclosure includes a roof side rail 20 disposed in a longitudinal direction of the vehicle on a side surface of a roof of a vehicle 1 and includes an auxiliary rail 23 formed in the longitudinal direction of the vehicle 1. The auxiliary rail 23 is fastened to an outer side of the vehicle 1 in a width direction at the roof side rail 20 and has weather strips 31 and 32 mounted thereon to seal a gap between a roof panel 50 mounted on the roof and a door glass 61.

The roof side rail assembly for a vehicle according to an embodiment of the present disclosure may be applied to the vehicle 1 in which the roof panel 50 of the vehicle 1 is detachably installed.

The roof side rail 20 provided in the roof side rail assembly is installed in the longitudinal direction of the vehicle 1 at both ends of the roof 2 of the vehicle 1 and serves to support side ends of the roof panel 50 when the roof 2 panel 50 is mounted.

A front rail 11 and the roof side rail 20 are provided on a perimeter of the roof of the vehicle 1. A center rail 12 is provided in a width direction of the vehicle generally in the middle of the vehicle roof. The roof panel 50 is supported by the front rail 11, the roof side rail 20, and the center rail 12. In other words, the front rail 11 supports a front end of the roof panel 50, the roof side rail 20 supports both side ends of the roof panel 50, and the center rail 12 supports the middle of the roof panel 50. A rear end of the roof panel 50 is supported by a rear pillar 15. The middle of the roof side rail 20 is supported by the center pillar 13. A part at which the front rail 11 is connected to the roof side rail 20 is supported by the front pillar 14.

When the roof panel 50 is detached from the vehicle 1, the roof side rail 20 is exposed to the outside to become the exterior of side ends of the roof 2 of the vehicle 1.

The roof side rail 20 includes a roof side outer part (also referred to as a roof side outer) 21 formed to have a cross-section that is convex outward of the vehicle 1, and a roof side inner part (also referred to as a roof side inner) 22 formed to have a cross-section that is convex inward of the vehicle 1 and assembled to the roof side outer 21. The roof side outer 21 and the roof side inner 22 are assembled to form a closed cross section structure.

The roof side outer 21 and the roof side inner 22 are integrated by having upper and lower ends assembled by welding, and the like.

To this end, an outer upper flange part 21a and an outer lower flange part 21b are formed on upper and lower portions of the roof side outer 21, respectively. An inner upper flange part 22a and an outer lower flange part 21b are formed on upper and lower portions of the roof side inner 22, respectively. In other words, the outer upper flange part 21a is formed to face the inside of the vehicle 1 on an upper portion of the roof side outer 21. The inner upper flange part 22a formed to face the outside of the vehicle 1 and overlapping the outer upper flange part 21a is formed on an upper portion of the roof side inner 22.

In addition, the outer lower flange part 21b is formed to face a lower side of the vehicle 1 on a lower portion of the roof side outer 21. The inner lower flange part 22b extending in the same direction as the outer lower flange part 21b and assembled to the outer lower flange part 21b is formed on a lower portion of the roof side inner 22.

Therefore, the roof side outer 21 and the roof side inner 22 are assembled in a state in which the outer upper flange part 21a and the inner upper flange part 22a, which are formed in opposite directions without protruding upward from the upper portions, overlap each other. The roof side outer 21 and the roof side inner 22 are assembled by welding the outer upper flange part 21a and the inner upper flange part 22a.

The lower portions of the roof side outer 21 and the roof side inner 22 are also assembled by welding the outer lower flange part 21b and the inner lower flange part 22b in a state of being in contact.

When the roof panel 50 is mounted on the roof side rail 20, weather strips 31, 32, and 33 for sealing gaps between the roof panel 50, the door glass 61, and the roof side rail 20 are installed to form a roof side assembly. One weather strip 33 of the weather strips 31, 32, and 33 is directly mounted on the roof side rail 20. However, the remaining weather strips 31 and 32 are mounted using a separate component.

The auxiliary rail 23 is fastened to the roof side rail 20. The auxiliary rail 23 is fastened to the outer side of the vehicle 1 at the roof side rail 20. In other words, the auxiliary rail 23 is fastened to the roof side outer 21 and thus fastened to the outer side of the vehicle 1 at the roof side rail 20.

The auxiliary rail 23 is formed in the longitudinal direction of the vehicle 1 and is fastened to the outer side of the vehicle 1 in the width direction at the roof side rail 20. The weather strips 31 and 32 for sealing the gap between the roof panel 50 and the door glass 61 that are mounted on the roof are mounted.

The upper roof weather strip 31 for sealing the gap between the roof panel 50 and the roof side rail 20 is fitted into an upper portion of the auxiliary rail 23. The lower roof weather strip 32 for sealing the gap between the door glass 61 installed on the door 60 and a vehicle body 10 is fitted into a lower portion of the auxiliary rail 23. The body weather strip 33 for sealing the gap between the door glass 61 and the vehicle body 10 below the lower roof weather strip 32 is installed on the lower portion of the roof side rail 20.

A shape of the auxiliary rail 23 is described in detail as follows.

The auxiliary rail 23 includes a fastening part 23a assembled to an outer surface of the roof side rail 20, and an extension 23b extending from the fastening part 23a to the outside in the width direction of the vehicle 1.

The fastening part 23a is assembled to the outer surface of the roof side rail 20, i.e., an outer surface of the roof side outer 21. The fastening part 23a has a shape having a cross section in contact with the roof side outer 21 so that, after the auxiliary rail 23 is assembled to the roof side rail 20, the auxiliary rail 23 maintains a state of being firmly assembled to the roof side rail 20.

The extension 23b extends from the fastening part 23a to the outside of the vehicle 1.

The extension 23b is formed to protrude from the fastening part 23a so that the upper roof weather strip 31 and the lower roof weather strip 32 are mounted to the auxiliary rail 23 using the fastening part 23a and the extension 23b. For example, end portions of the fastening part 23a and the extension 23b are formed in a shape that makes it easy to mount the upper roof weather strip 31 and the lower roof weather strip 32 so that the upper roof weather strip 31 and the lower roof weather strip 32 are mounted.

To mount the upper roof weather strip 31 and the lower roof weather strip 32 on the auxiliary rail 23, the fastening part 23a has upper and lower ends formed with an upper hook part 23c and a lower hook part 23f, respectively. In addition, the extension 23b has an end portion formed with a center hook part 23d and a catch part 23e. In other words, the center hook part 23d of the auxiliary rail 23 extends vertically from an end portion of the extension 23b. Also, an upper gripping part 32b, which is one side of the lower roof weather strip 32, is fixedly fitted into the center hook part 23d. The catch part 23e extends downward from the center hook part 23d to catch and fix the one side of the lower roof weather strip 32 so that the lower roof weather strip 32 is not separated.

The auxiliary rail 23 is formed in an H shape as the fastening part 23a and the center hook part 23d each extend vertically from one of both ends of the extension 23b.

The auxiliary rail 23 forms a constant cross-sectional shape in the longitudinal direction of the vehicle 1 and the upper roof weather strip 31 and the lower roof weather strip 32 are mounted at the outer side of the auxiliary rail 23. Therefore, since the roof side rail 20 has a smooth shape without a step at a part that is connected to the center pillar 13, and the like, aesthetics is improved when the roof panel 50 is detached.

The upper roof weather strip 31 is fixed to an upper end of the fastening part 23a above the extension 23b to be mounted on the auxiliary rail 23. The upper roof weather strip 31 serves to seal a gap between a bottom surface of the perimeter of the roof panel 50 and the roof side rail 20.

The upper roof weather strip 31 includes a fixing part 31a fastened to the auxiliary rail 23 and includes a roof bottom sealing part 31b formed convexly toward the bottom surface of the roof panel 50 to be in contact with a lower end of the roof panel 50 and allowing the upper roof weather strip 31 to have a hollow together with the fixing part 31a.

The extension 23b is sealed with the roof panel 50 at the upper portion of the extension 23b and is sealed with the door glass 61 at the lower portion of the extension 23b. Therefore, the roof panel 50 and the door glass 61 may be independently sealed to the extension 23b so that the roof panel 50 and the door glass 61 may be independently mounted or detached. In other words, since the side ends of the roof panel 50 are sealed in contact with the side surfaces of the upper roof weather strip 31 and the lower roof weather strip 32, and since an upper end of the door glass 61 is sealed in contact with the lower portion of the lower roof weather strip 32, the roof panel 50 and the door glass 61 may be independently, detachably attached without mutually affecting.

The fixing part 31a has one side fixedly caught on the upper hook part 23c and the other side fixed to the lower roof weather strip 32 so that the upper roof weather strip 31 is fixed to the auxiliary rail 23.

The roof bottom sealing part 31b extends from the fixing part 31a so that the fixing part 31a and the roof bottom sealing part 31b form a closed cross section. Since the roof bottom sealing part 31b is formed convexly toward the bottom surface of the roof panel 50, the roof bottom sealing part 31b is in contact with the bottom surface of the roof panel 50 when the roof panel 50 is mounted to seal the gap between the bottom surface of the perimeter of the roof panel 50 and the roof side rail 20. Both side ends of the roof bottom sealing part 31b extend to be in contact with the roof side outer 21 and the lower roof weather strip 32.

The upper roof weather strip 31 is also formed to have the above-described cross-sectional structure in the longitudinal direction of the vehicle 1.

The lower roof weather strip 32 is fixed to the end portion of the extension 23b and a lower end of the fastening part 23a to be mounted on the auxiliary rail 23. The lower roof weather strip 32 serves to seal the gap between the perimeter of the roof panel 50 and the door glass 61.

The center hook part 23d and the catch part 23e are formed on the end portion of the extension 23b so that the lower roof weather strip 32 is mounted on the auxiliary rail 23.

The lower roof weather strip 32 includes a support part 32a supported on a bottom surface of the extension 23b, the upper gripping part 32b fixedly caught on the center hook part 23d, and a roof side sealing part 32d that seals the perimeter of the roof panel 50 at the end portion of the lower roof weather strip 32.

The support part 32a becomes a body of the lower roof weather strip 32 and is supported by the extension 23b of the auxiliary rail 23 so that the lower roof weather strip 32 mounted on the auxiliary rail 23 maintains a predetermined shape.

The roof side sealing part 32d is formed to have a cross section that is convex to the outside of the vehicle 1 at the end portion of the lower roof weather strip 32. When the roof panel 50 is installed, the roof side sealing part 32d is in contact with the perimeter of the roof panel 50 to seal the gap between the perimeter of the roof panel 50 and the auxiliary rail 23. Therefore, the roof side sealing part 32d prevents a foreign substance or noise from being introduced through the perimeter of the roof panel 50.

The roof side sealing part 32d has one side formed with an opening 32c rather than the closed cross section. The opening 32c allows the center hook part 23d and the catch part 23e of the auxiliary rail 23 to pass therethrough.

The upper gripping part 32b is formed in a shape that is caught on the center hook part 23d. Since a portion of the lower roof weather strip 32 is formed to pass through the opening 32c, the upper gripping part 32b is formed adjacent to the opening 32c.

A fixing groove 32e formed concavely toward the inside of the vehicle 1 to be caught on (e.g., engaged with, held on, and/or secured by) the catch part 23e is formed inside the roof side sealing part 32d. The fixing groove 32e is caught on the catch part 23e to prevent the roof side sealing part 32d fitted to the end portion of the auxiliary rail 23 from being separated. Therefore, it is possible to prevent the lower roof weather strip 32 from being separated from the outer side of the vehicle 1 in the width direction.

To seal the upper end of the door glass 61 in the lower roof weather strip 32, a glass upper sealing part 32f is formed. The glass upper sealing part 32f extends from the roof side sealing part 32d to the inside of the vehicle and forms a hollow structure together with the support part 32a. Therefore, when the door glass 61 maximally moves upward, the upper end of the door glass 61 is in contact with the glass upper sealing part 32f to seal the gap between the auxiliary rail 23 and the door glass 61. Since the glass upper sealing part 32f is formed convexly toward the upper end of the door glass 61, the upper end of the door glass 61 is easily sealed.

The lower roof weather strip 32 has a first glass side sealing part 32g formed from the glass upper sealing part 32f to the inside of the vehicle 1. The first glass side sealing part 32g extends from an inner end portion of the support part 32a and is located below the glass upper sealing part 32f. The first glass side sealing part 32g is also formed in a hollow structure. When the door glass 61 moves upward, the first glass side sealing part 32g is in contact with an inner surface of the door glass 61 to seal the inner surface of the door glass 61.

A lower gripping part 32h is formed to protrude from one side of the first glass side sealing part 32g. The lower gripping part 32h is fixedly caught on (e.g., engaged with, held on, and/or secured by) the lower hook part 23f of the auxiliary rail 23 so that an inner end portion of the lower roof weather strip 32 is firmly coupled to the auxiliary rail 23.

The lower roof weather strip 32 is also formed in the longitudinal direction of the vehicle 1 and its cross section has the above-described configuration.

The body weather strip 33 for sealing the inner surface of the door glass 61 is additionally fitted into the lower portion of the roof side rail 20.

The body weather strip 33 includes an insertion part 33a into which the lower end of the roof side rail 20 is inserted and includes a second glass side sealing part 33b extending from the insertion part 33a to the outside of the vehicle and formed to have a hollow therein.

The insertion part 33a allows the lower end of the roof side rail 20, i.e., a part where the outer lower flange part 21b and the inner lower flange part 22b are assembled, to be fitted so that the body weather strip 33 for sealing the door glass 61 is also mounted on the roof side rail 20.

The second glass side sealing part 33b extends from the insertion part 33a to the outside of the vehicle 1 and is formed to have a hollow therein to seal the inner surface of the door glass 61. The second glass side sealing part 33b seals the inner surface of the door glass 61 below the first glass side sealing part 32g.

In the body weather strip 33, a trim sealing part 33c extending from the insertion part 33a toward the inside of the vehicle 1 is formed. The trim sealing part 33c seals a gap between the roof side rail 20 and a trim 41.

An operation of the roof side rail assembly for a vehicle according to the present disclosure having the above structure will be described as follows.

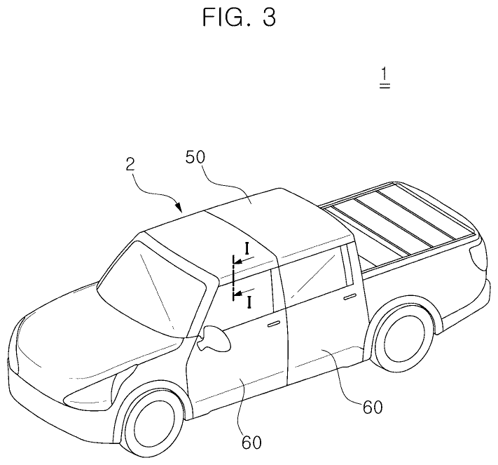

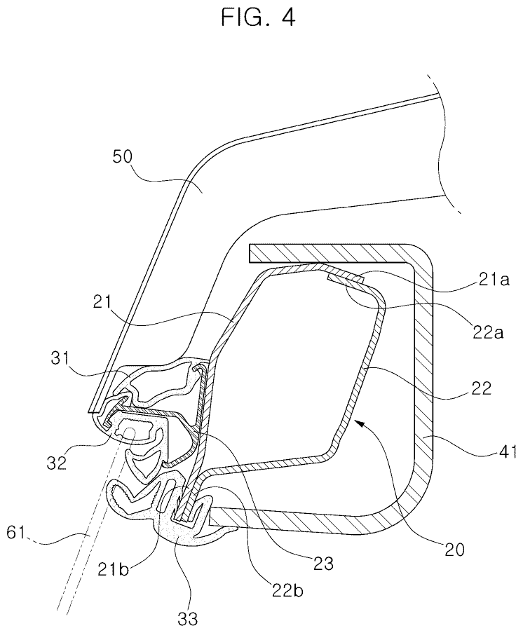

FIGS. 3-4 show a state in which the roof panel 50 has been mounted.

In a state in which the roof panel 50 has been mounted on the roof, the perimeter of the roof panel 50 is double-sealed in contact with the roof side sealing part 32d and the roof bottom sealing part 31b. As described above, since the perimeter of the roof panel 50 is double-sealed by the upper roof weather strip 31 and the lower roof weather strip 32 in the state in which the roof panel 50 has been mounted, it is possible to block a foreign substance, moisture, or noise from being introduced from the outside.

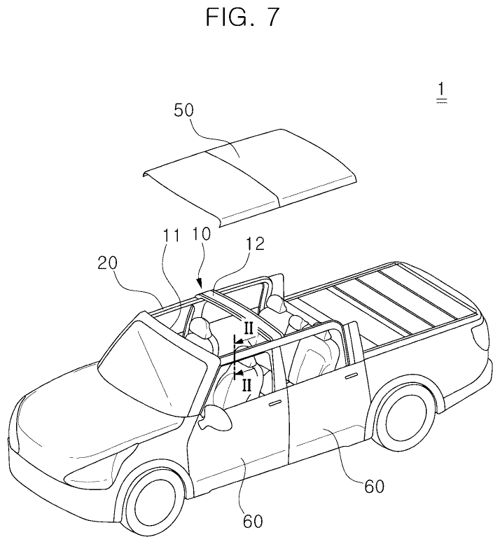

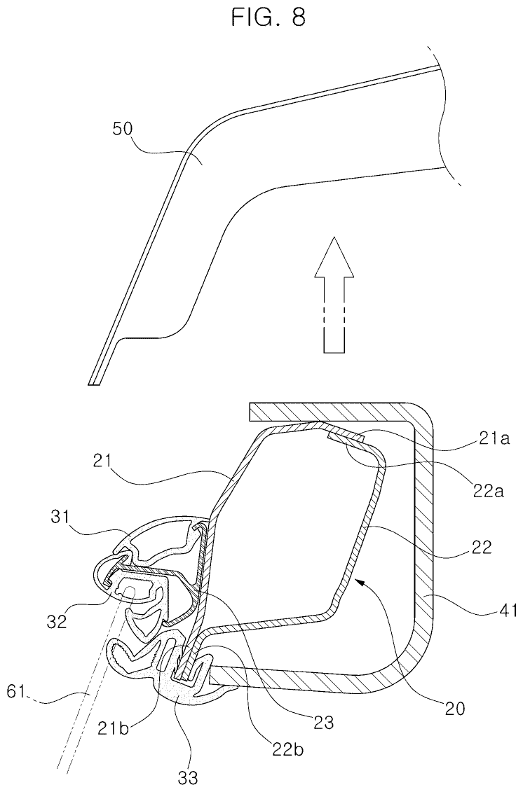

FIGS. 7-8 show a state in which the roof panel 50 has been detached.

When the roof panel 50 is detached, the perimeter of the roof panel 50 is separated from the roof side sealing part 32d and the roof bottom sealing part 31b. As the roof panel 50 is detached, the roof 2 of the vehicle 1 is opened so that the passenger may feel an expanded sense of openness.

In the roof side rail assembly according to an embodiment of the present disclosure, a sealing structure is not applied to the roof panel 50 side and the upper roof weather strip 31 and the lower roof weather strip 32 are installed to the roof side rail 20 side through the auxiliary rail 23. Therefore, it is possible to prevent damage to the weather strips 31 and 32 even when the roof panel is detachably attached repeatedly, thereby preventing bad sealing due to the damaged weather strips 31 and 32. When the upper roof weather strip 31 and the lower roof weather strip 32 are installed at the roof panel 50 side, the upper roof weather strip 31 and the lower roof weather strip 32 may be damaged in contact with another object while the roof panel 50 is detached and stored, which may cause poor sealing when the roof panel 50 is mounted. However, as in an embodiment of the present disclosure, since the upper roof weather strip 31 and the lower roof weather strip 32 are installed at the roof side rail 20 side through the auxiliary rail 23, it is possible to prevent damage to the upper roof weather strip 31 and the lower roof weather strip 32 when the removed roof panel 50 is stored.

When the door glass 61 maximally moves upward, the door glass 61 is sealed by the lower roof weather strip 32 and the body weather strip 33 regardless of the installation of the roof panel 50. In other words, in the state in which the door glass 61 is moved upward to its maximum extent, the upper end of the door glass 61 is sealed by the glass upper sealing part 32f of the lower roof weather strip 32 and an upper inner surface of the door glass 61 is sealed by the first glass side sealing part 32g of the lower roof weather strip 32 and the second glass side sealing part 33b of the body weather strip 33.

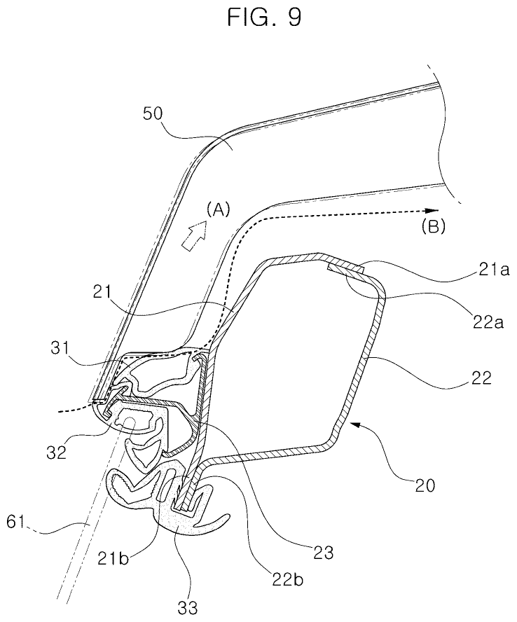

FIG. 9 shows a cross section of the roof panel 50 when assembly dispersion occurs. Even though a location of the roof panel 50 is slightly changed by dispersion when the roof panel 50 is mounted, poor sealing does not occur in the roof side rail assembly according to the present disclosure. FIG. 9 shows a state in which the roof panel 50 has been assembled in a state in which dispersion of the roof panel 50 has occurred rightward and upward (see arrow A) compared to FIG. 4. When the assembly dispersion occurs as described above, a foreign substance, noise, etc. may be introduced through a path such as arrow B. However, in the roof side rail assembly according to an embodiment of the present disclosure, despite the assembly dispersion of the roof panel 50, the perimeter of the roof panel 50 is sealed by the roof side sealing part 32d and the roof bottom sealing part 31b, thereby preventing bad sealing.

The present disclosure has been described with reference to the example embodiments and the drawings, but the present disclosure is not limited thereby. The present disclosure may be carried out in various forms by those having ordinary skill in the art, to which the present disclosure pertains, within the technical spirit of the present disclosure and the scope of equivalents to the appended claims.

What is claimed is:

1. A roof side rail assembly for a vehicle, the roof side rail assembly comprising:
a roof side rail disposed along a longitudinal direction of the vehicle on each of side surfaces of a roof of the vehicle; and
an auxiliary rail formed along the longitudinal direction of the vehicle adjacent each of the roof side rails,
wherein each auxiliary rail is fastened to an outer side of the vehicle in a width direction at the respective roof side rail and has a weather strip sealing a gap between a roof panel mounted on the roof and a door glass mounted on the roof.

2. The roof side rail assembly of claim 1, further comprising:
an upper roof weather strip installed above each auxiliary rail to seal a gap between the roof panel and the respective roof side rail; and
a lower roof weather strip having one side fitted into an end portion of each auxiliary rail and installed below the respective auxiliary rail to seal gaps between the roof panel, the door glass, and a vehicle body.

3. The roof side rail assembly of claim 2, wherein each auxiliary rail includes:
a fastening part assembled to an outer surface of the respective roof side rail; and
an extension extending outward from the fastening part in the width direction of the vehicle,
wherein the upper roof weather strip is fixed to an upper end of the fastening part above the extension, and
wherein the lower roof weather strip is fixed to an end portion of the extension and a lower end of the fastening part.

4. The roof side rail assembly of claim 3, wherein the upper roof weather strip includes:
a fixing part fastened to the auxiliary rail; and
a roof bottom sealing part formed convexly toward a bottom surface of the roof panel to be in contact with a lower end of the roof panel and allowing the upper roof weather strip to have a hollow together with the fixing part.

5. The roof side rail assembly of claim 4, wherein:
each auxiliary rail further includes an upper hook part formed at an upper end of the fastening part; and
one side of the fixing part of the upper roof weather strip is coupled to the upper hook part, and another side of the fixing part is fixed to the lower roof weather strip.

6. The roof side rail assembly of claim 3, wherein:
the extension has an upper portion sealed with the roof panel and a lower portion sealed with the door glass; and
the roof panel and the door glass are independently sealed to the extension.

7. The roof side rail assembly of claim 6, wherein a side end of the roof panel is sealed in contact with side surfaces of the upper roof weather strip and the lower roof weather strip.

8. The roof side rail assembly of claim 6, wherein an upper end of the door glass is sealed in contact with a lower portion of the lower roof weather strip.

9. The roof side rail assembly of claim 3, wherein each auxiliary rail includes:
a center hook part extending vertically from the end portion of the extension and allowing one side of the lower roof weather strip to be fixedly fitted into the center hook part;
a catch part extending downward from the center hook part to catch and fix the one side of the lower roof weather strip to prevent separation of the lower roof weather strip; and
a lower hook part formed at the lower end of the fastening part to fix another side of the lower roof weather strip.

10. The roof side rail assembly of claim 9, wherein each auxiliary rail is formed in an H shape as the fastening part and the center hook part each extends vertically from one of both ends of the extension.

11. The roof side rail assembly of claim 9, wherein the lower roof weather strip includes:
a support part supported by a bottom surface of the extension;
an upper gripping part fixedly caught on the center hook part; and
a roof side sealing part sealing a perimeter of the roof panel at an end portion of the lower roof weather strip.

12. The roof side rail assembly of claim 11, wherein the lower roof weather strip has an opening through which the center hook part and the catch part of the respective auxiliary rail pass formed between the support part and the upper gripping part.

13. The roof side rail assembly of claim 11, wherein a fixing groove is formed inside the roof side sealing part, wherein the fixing groove is fixedly caught on the catch part.

14. The roof side rail assembly of claim 13, wherein each roof side rail includes:
a roof side outer part formed to have a cross section that is convex to an outside of the vehicle; and
a roof side inner part formed to have a cross section that is convex to an inside of the vehicle and having upper and lower portions respectively assembled to upper and lower portions of the roof side outer part, and
wherein the respective auxiliary rail is fastened to the roof side outer part.

15. The roof side rail assembly of claim 14, further comprising:
an outer lower flange part formed to face a lower portion of the vehicle below the roof side outer part;
an inner lower flange part extending from the lower portion of the roof side inner part in a same direction as the outer lower flange part and assembled to the outer lower flange part; and
a body weather strip fitted into the outer lower flange part and the inner lower flange part to seal a gap between an upper portion of the door glass and the roof side rail.

16. The roof side rail assembly of claim 15, wherein the body weather strip seals side surfaces of the door glass below the lower roof weather strip.

17. The roof side rail assembly of claim 14, further comprising:
an outer upper flange part formed to face the inside of the vehicle above the roof side outer; and
an inner upper flange part formed to face the outside of the vehicle above the roof side inner and overlapping the outer upper flange part, and
wherein the outer upper flange part and the inner upper flange part are assembled so that upper portions of the roof side outer and the roof side inner are assembled.

18. The roof side rail assembly of claim 11, further comprising a glass upper sealing part extending from the roof side sealing part to an inside of the vehicle, forming a hollow structure together with the support part, and sealing the upper end of the door glass.

19. The roof side rail assembly of claim 18, further comprising:
a first glass side sealing part extending from an inner end portion of the support part and sealing an inner upper portion of the door glass below the glass upper sealing part; and
a lower gripping part protruding from a side surface of the first glass side sealing part and fixed by being caught by the lower hook part.
